(19) United States
(12) Patent Application Publication
(10) Pub. No.: US 2025/0320763 A1
(43) Pub. Date: Oct. 16, 2025

(54) RADIOFREQUENCY TRANSMISSION AND RECEPTION DEVICE FOR DETECTING THE AUTOMATIC OPENING OF A VEHICLE OPENING PANEL

(71) Applicant: Vitesco Technologies GmbH, Regensburg (DE)

(72) Inventors: Ihssen MASRI, Angouleme (FR); Nhu Huan NGUYEN, Grenoble (FR); Tan Phu VUONG, Saint Martin d'Hère (FR)

(73) Assignee: Vitesco Technologies GmbH, Regensburg (DE)

(21) Appl. No.: 18/864,950

(22) PCT Filed: May 19, 2023
(86) PCT No.: PCT/EP2023/063473

§ 371 Date: Nov. 12, 2024

(30) Foreign Application Priority Data
May 25, 2022 (FR) FR2205017

(51) Int. Cl. E05F 15/73; G01S 13/50; G01S 13/88; G06F 3/01

(52) U.S. Cl. CPC E05F 15/73; G01S 13/50; G01S 13/88; E05Y 2400/664; E05Y 2900/53; G06F 3/017

(57) ABSTRACT

A reflector, intended to form an integral part of a device for transmitting and receiving radio-frequency signals, for a gesture detector controlling automatic opening of a motor-vehicle hatch. The reflector including a reflecting plate, capable of reflecting a radio-frequency beam; at least one fastening tab, each fastening tab being integrally formed with the reflecting plate, and each fastening tab being configured to be inserted into a respective orifice passing through a thickness of a printed circuit board, and to be soldered to the printed circuit board at the orifice. The printed circuit board includes at least one radio-frequency antenna.

### CROSS REFERENCE TO RELATED APPLICATIONS

This application is the U.S. National Phase Application of PCT International Application No. PCT/EP2023/063473, filed May 19, 2023, which claims priority to French Patent Application No. 2205017, filed May 25, 2022, the contents of such applications being incorporated by reference herein.

### TECHNICAL FIELD OF THE INVENTION

The present invention relates to a device for transmitting and/or receiving a radio-frequency signal, which device is intended to form an integral part of a gesture detector controlling automatic opening of a motor-vehicle hatch (the term ‘hatch’ being understood here to mean a passenger-compartment door, a trunk lid, a frunk lid or a hood of the vehicle), the device being equipped with a reflector according to the invention.

The device according to the invention is for example applicable to a vehicle equipped with a hands-free access system, allowing a user of the vehicle to open a door or the trunk thereof, simply by making a gesture, without physical contact either with the vehicle or with a keycard or other activating key.

### TECHNOLOGICAL BACKGROUND OF THE INVENTION

At the present time, many systems are being developed, with hands-free access, that automatically open hatches of the vehicle when the user makes a predetermined gesture of a limb of her or his body near to the vehicle. This predetermined gesture may be detected by means of a radio-frequency detector placed in a bumper, rear-view mirror, B-pillar or handle of the vehicle.

For example, in the case of opening a vehicle trunk, it is known to use gesture detection based on a device for transmitting and receiving radio-frequency signals. Such a device is placed in the rear bumper of the vehicle. This device is equipped with two radio-frequency antennas, a first antenna transmitting a radio-frequency beam rearward from the vehicle and a second antenna transmitting a radio-frequency beam toward the ground. Thus, when a user makes a foot movement that passes through the two radio-frequency beams, the detector detects a desire to open the trunk of the vehicle and triggers opening thereof.

However, problems with untimely opening of hatches are sometimes encountered. Specifically, the radio-frequency beams overlap and are not exactly differentiated meaning that the movement of a foot near the bumper is sometimes enough to open the trunk of the vehicle without the user having wished it. The detection ratio, which is the ratio of the detection rate to the false-detection rate, is very often too low.

### SUMMARY OF THE INVENTION

One aspect of the invention aims to provide a way of reducing a false-detection rate of a device for transmitting and receiving radio-frequency signals such as described in the introduction.

In this context, an aspect of the invention thus relates, in its broadest acceptance, to a device for transmitting and receiving radio-frequency signals, for a gesture detector controlling automatic opening of a motor-vehicle hatch, said device being equipped with a reflector comprising:
a reflecting plate, capable of reflecting a radio-frequency beam,
at least one fastening tab, each fastening tab being integrally formed with the reflecting plate, and each fastening tab being configured to be inserted into a respective orifice passing through a thickness of a printed circuit board, and to be soldered to the printed circuit board at the orifice, the printed circuit board comprising at least one radio-frequency antenna.

This reflector is intended to be soldered to a printed circuit board equipped with a radio-frequency antenna. It makes it possible to shape a radiation pattern of the antenna, to make it more selective. It is in particular a question of concentrating the electromagnetic field in a desired region of coverage, and consequently of reducing the electromagnetic field outside of this region of coverage.

Thus, the reflector according to an aspect of the invention thus increases the detection rate, reduces the false-detection rate and avoids cases of a hatch opening without the user having wished it.

Furthermore, the reflector according to an aspect of the invention is configured to be integrated into a printed circuit board in a very simple manner, simply by pressing at least one of its fastening tabs into a corresponding orifice in the printed circuit board, and by soldering the fastening tab to the corresponding orifice. This arrangement allows the reflector to be mechanically fastened to the printed circuit board very easily. This arrangement also allows the reflector to be oriented with any desired orientation, relative to the plane of the printed circuit board. Thus, advantageously, the reflector, and more particularly the constituent surface of largest extent of said reflector, is inclined obliquely relative to the plane of the printed circuit board. This inclination makes between the reflector and the plane of the printed circuit board an angle, for example, between 10° and 80°, or even between 20° and 70°, or even between 34° and 55°.

The reflector according to an aspect of the invention may consist entirely of the reflecting plate and of the at least one fastening tab.

In addition to the features just mentioned in the preceding passage, the reflector according to this aspect of the invention may have one or more additional features among the following, considered individually or in any technically possible combination.

According to one non-limiting aspect of the invention, the reflecting plate comprises at least one notch that passes right through the thickness of the reflecting plate.

According to a non-limiting aspect of the invention, the reflecting plate is made of metal.

Another aspect of the invention relates to a device for transmitting and receiving radio-frequency signals, for a gesture detector controlling automatic opening of a motor-vehicle hatch, the device comprising:
a printed circuit board, equipped with at least one radio-frequency antenna, and passed through by at least one orifice; and
at least one reflector according to any one of the aforementioned aspects of the invention, at least one fastening tab of each at least one reflector being inserted into a respective orifice of the printed circuit board, and soldered to the printed circuit board at the orifice.

According to one non-limiting aspect of the invention, the at least one reflector has a major surface, which is inclined obliquely relative to the plane of the printed circuit board, with an angle of inclination between 20° and 70°.

According to an aspect of the invention, the printed circuit board is equipped with a first side and a second side that face each other, one of the first and second sides being equipped with a first radio-frequency antenna, the device further comprising a first reflector according to any one of the aforementioned aspects of the invention, each fastening tab of the first reflector being inserted into a respective orifice passing through a thickness of the printed circuit board and being soldered to the printed circuit board at the orifice, the reflecting plate of the first reflector facing the first side.

According to an aspect of the invention, the device further comprises a second reflector according to any one of the aforementioned aspects of the invention, each fastening tab of the second reflector being inserted into a respective orifice passing through the thickness of the printed circuit board and being soldered to the printed circuit board at the orifice, the reflecting plate of the second reflector facing the second side.

According to one non-limiting aspect of the invention, the first reflector and the second reflector flank the first radio-frequency antenna.

According to one nonlimiting aspect of the invention,
the printed circuit board is equipped with at least two radio-frequency antennas; and
the device comprises at least two sets of one or more reflectors, where each set of one or more reflectors comprises at least one reflector according to any one of the aforementioned aspects of the invention, and where each set of one or more reflectors is associated with a respective one of the at least two radio-frequency antennas.

In use, at least one fastening tab of each at least one reflector is inserted into a respective orifice of the printed circuit board, and soldered to said printed circuit board at said orifice.

The sets of reflectors are configured to improve the differentiation between the respective radiation patterns associated with each of the radio-frequency antennas, in comparison with an identical device without reflectors. In particular, the sets of reflectors are configured to increase a spacing between a radiation maximum of one radio-frequency antenna and the radiation of the other radio-frequency antenna in the same direction. Where appropriate, the second set of reflectors allows a shadow region to be created between the radiation delivered by the two antennas, to further improve the separation between the radiation that they respectively transmit.

According to one nonlimiting aspect of the invention,
the printed circuit board is equipped with a first side and a second side that face each other, one of said first and second sides being equipped with a first radio-frequency antenna, the device further comprising a first reflector according to any one of the aforementioned aspects of the invention, each fastening tab of the first reflector being inserted into a respective orifice passing through a thickness of the printed circuit board and being soldered to the printed circuit board at the orifice, the reflecting plate of the first reflector facing the first side;
the device further comprises a second reflector according to any one of the aforementioned aspects of the invention, each fastening tab of the second reflector being inserted into a respective orifice passing through the thickness of the printed circuit board and being soldered to the printed circuit board at the orifice, the reflecting plate of the second reflector facing the second side; and
one of the first and second sides of the printed circuit board is equipped with a second radio-frequency antenna, the device further comprising a third reflector according to any one of the aforementioned aspects of the invention, each fastening tab of the third reflector being inserted into a respective orifice passing through the thickness of the printed circuit board and being soldered to the printed circuit board at the orifice, the reflecting plate of the third reflector facing the first side or second side.

According to one non-limiting aspect of the invention, the printed circuit board comprises a ground plane, each fastening tab being electrically connected to the ground plane.

According to one non-limiting aspect of the invention, the printed circuit board comprises a ground plane, the ground plane covering the first radio-frequency antenna.

According to one non-limiting aspect of the invention, the printed circuit board comprises a ground plane, the ground plane covering the second radio-frequency antenna.

Another aspect of the invention relates to a gesture detector for controlling automatic opening of a motor-vehicle hatch, comprising:
a device according to any one of the aforementioned aspects of the invention; and
at least one computer, configured to receive as input a signal from at least one radio-frequency antenna, to carry out processing on this signal so as to detect a predetermined gesture made by a human operator, and to generate an instruction to open the motor-vehicle hatch when a predetermined gesture is detected.

An aspect of the invention and its various applications will be better understood upon reading the following description and studying the accompanying figures.

### BRIEF DESCRIPTION OF THE FIGURES

The figures are indicative and in no way limitative of aspects of the invention.

FIG. 1 shows a profile view of a reflector, according to one non-limiting aspect of the invention.

FIG. 2 is a front view of the reflector shown in FIG. 1.

FIG. 3 illustrates another non-limiting example of embodiment of a reflector according to the invention.

FIG. 4 illustrates one non-limiting example of embodiment of a device for transmitting and receiving radio-frequency signals, for a gesture detector controlling automatic opening of a motor-vehicle hatch, according to one aspect of the invention.

FIG. 5 shows a different view of the device for transmitting and receiving radio-frequency signals illustrated in FIG. 4.

FIG. 6 shows a radiation pattern of radio-frequency beams transmitted by the device illustrated in FIGS. 4 and 5.

FIG. 7 illustrates another non-limiting example of embodiment of a device for transmitting and receiving radio-frequency signals, for a gesture detector controlling automatic opening of a motor-vehicle hatch, according to one aspect of the invention.

FIG. 8 illustrates a different non-limiting example of embodiment of a device for transmitting and receiving radio-frequency signals, for a gesture detector controlling automatic opening of a motor-vehicle hatch, according to one aspect of the invention.

FIG. 9 shows a gesture detector for controlling automatic opening of a motor-vehicle hatch according to one aspect of the invention.

FIG. 10 illustrates a gesture detector for controlling automatic opening of a motor-vehicle hatch according to another aspect of the invention.

### DETAILED DESCRIPTION OF THE INVENTION

Unless otherwise specified, a given element appearing in different figures has been designated by a single reference.

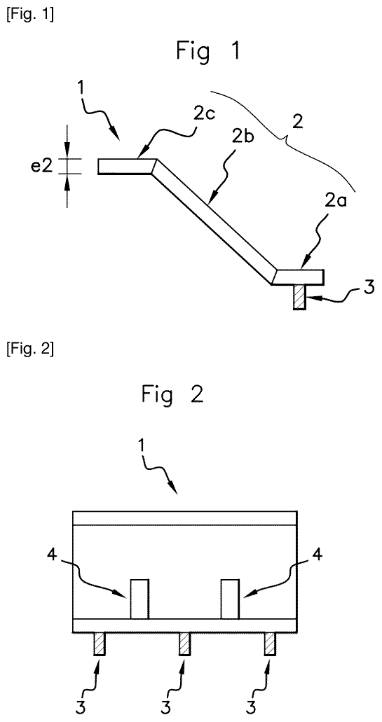

FIGS. 1 and 2 show one example of embodiment of a reflector 1 according to one aspect of the invention, this reflector 1 being intended to form an integral part of a device for transmitting and receiving radio-frequency signals for a gesture detector controlling automatic opening of a motor-vehicle hatch. More particularly, FIG. 1 is a profile view of this reflector 1 and FIG. 2 is a front view of the reflector 1.

The reflector 1 is composed of a plate 2 for reflecting a radio-frequency beam. This reflecting plate 2 here has three planar portions, a first portion 2a, a second portion 2b and a third portion 2c. In this non-limiting example of embodiment, the reflecting plate 2 forms a Z. In order to reflect the radio-frequency beam, this reflecting plate 2 may be made of metal, of aluminum for example.

As illustrated in FIG. 2, and non-limitingly, the reflector 1 is further composed of three fastening tabs 3 integrally formed with the reflecting plate 2. Each fastening tab 3 is arranged to be positioned in a respective orifice of a printed circuit board, and soldered in said orifice. Non-limitingly, each of the fastening tabs may be planar and have a width between 0.2 mm and 1.0 mm, of 0.5 mm for example, and a length between 0.2 mm and 2 mm.

In this example of embodiment, the second portion 2b forms, when the reflector 1 is secured to a printed circuit board by means of the fastening tabs 3, a major surface, which is inclined obliquely relative to the plane of the printed circuit board, with an angle of inclination between 20° and 70°. This major surface 2b forms the planar surface of greatest extent among a plurality of constituent surfaces 2a, 2b, 2c of the reflector 1.

It will be noted that the printed circuit board is equipped with a radio-frequency antenna. The reflecting plate 2 thus forms, once mounted on the printed circuit board, a barrier that is reflective to a radio-frequency beam transmitted by the radio-frequency antenna. Throughout this text, the expression ‘radio-frequency beam’ designates a beam of electromagnetic radiation a carrier frequency of which is between 30 MHz and 300 GHz. Preferably, said frequency is between 3 GHz and 100 GHz, and for example centered on about 24 GHz, or about 77 GHz, or about 81 GHz, or about 60 GHz. Advantageously, the radio-frequency beam is a UWB signal (UWB standing for Ultra-Wide Band), the frequency spectrum of which extends from 3 GHz to 10 GHz. As a variant, the frequency spectrum may extend from 77 GHz to 81 GHz.

Here, but non-limitingly, the reflecting plate 2 further comprises two notches 4. Each notch 4 advantageously passes right through the thickness e2 of the reflecting plate 2. When the reflecting plate 2 is soldered to the printed circuit board, these notches 4 are placed facing conductive tracks on the printed circuit board, in order to avoid any electromagnetic interference. Here, and advantageously, each notch 4 extends from an edge of the reflecting plate 2.

In a different implementation (not shown), each of the notches 4 passes through only part of the thickness of the reflecting plate 2.

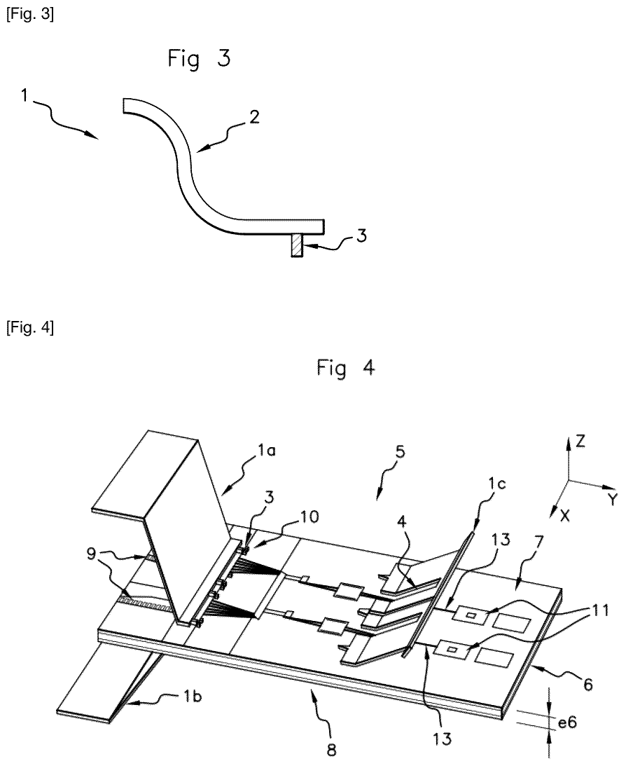

FIG. 3 is a profile view of another example of embodiment of a reflector 1 for a device for transmitting and receiving radio-frequency signals for a gesture detector controlling automatic opening of a motor-vehicle hatch. In this embodiment, the reflecting plate 2 is curved.

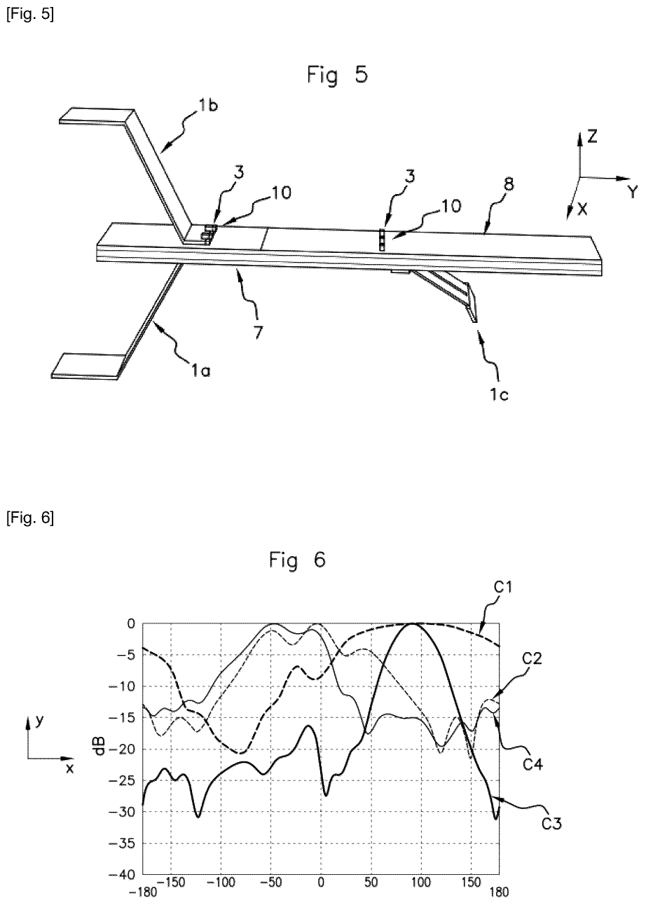

FIG. 4 illustrates one non-limiting example of embodiment of a device for transmitting and receiving radio-frequency signals, for a gesture detector controlling automatic opening of a motor-vehicle hatch according to one aspect of the invention. This device 5 may be used to detect a particular gesture of the user's foot, allowing the trunk of the vehicle to be opened automatically. FIG. 5 illustrates a different view of this example of embodiment.

The device 5 comprises a printed circuit board 6 having a first side 7 and a second side 8 that are parallel to each other.

The first side 7 is equipped with a first radio-frequency antenna 9, a Vivaldi antenna for example.

The device 5 further comprises a first reflector 1a. Each of the fastening tabs 3 of the first reflector 1a is placed in a respective orifice 10 passing through a thickness e6 of the printed circuit board 6. Here, but non-limitingly, the orifices 10 and the fastening tabs 3 pass right through the thickness of the printed circuit board 6. In variants (not shown), the orifices 10 and the fastening tabs 3 pass through only part of the total thickness of the printed circuit board 6. In this example, the fastening tabs 3 are soldered to the second side 8 of the printed circuit board 6. In order to facilitate soldering, the internal wall of the orifices 10 may be metallized.

It will moreover be noted that the reflecting plate 2 of the first reflector 1a lies facing the first antenna 9 and faces the first side 7 of the printed circuit board 6.

The device 5 comprises a second reflector 1b. Each of the fastening tabs 3 of the second reflector 1b is placed in a metallized orifice 10 passing through the thickness e6 of the printed circuit board 6. In this example, the fastening tabs 3 are soldered to the first side 7 of the printed circuit board 6.

It will moreover be noted that the reflecting plate 2 of the second reflector 1b lies facing the first antenna 9 and faces the second side 8 of the printed circuit board 6.

In this example of embodiment, the first reflector 1a and the second reflector 1b flank the first radio-frequency antenna 9. Thus, the radio-frequency beam transmitted by the first radio-frequency antenna 9 is oriented and constrained by the reflecting plates 2 of the first and second reflectors 1a, 1b.

In this embodiment, the first side 7 of the printed circuit board 6 is equipped with a second radio-frequency antenna 11, a patch antenna for example.

The device 5 further comprises a third reflector 1c. Each of the fastening tabs 3 of the third reflector 1c is placed in a metallized orifice 10 passing through the thickness e6 of the printed circuit board 6. In this example, the fastening tabs 3 are soldered to the second side 8 of the printed circuit board 6.

It will moreover be noted that the reflecting plate 2 of the third reflector 1c lies offset relative to the second radio-frequency antenna 11 and faces the first side 7 of the printed circuit board 6.

The printed circuit board 6 further comprises a ground plane (not shown specifically), which may in particular lie facing the second antenna 11.

Thus, the radio-frequency beam transmitted by the second radio-frequency antenna 11 is oriented and constrained by the reflecting plate 2 of the third reflector 1c (and by the ground plane, where appropriate).

Furthermore, the reflecting plate 2 of the third reflector 1c comprises two notches 4 passing through its thickness e2. Each of these notches 4 is placed facing a respective conductive track 13 that the printed circuit board 6 comprises. This arrangement makes it possible to avoid a risk of electromagnetic interference.

By virtue of the first, second and third reflectors 1a, 1b, 1c, the radio-frequency beam transmitted by the first radio-frequency antenna 9 and the radio-frequency beam transmitted by the second radio-frequency antenna 11 do not overlap. This particularity makes it possible to effectively discern a particular gesture. FIG. 6 allows this advantage to be illustrated.

More particularly, FIG. 6 illustrates a radiation pattern of a radio-frequency beam transmitted by the first radio-frequency antenna 9 and of a radio-frequency beam transmitted by the second radio-frequency antenna 11.

More particularly,
curve C1 illustrates the radiation pattern in the YOZ plane of a radio-frequency beam transmitted or received by a first radio-frequency antenna 9 of a device according to the prior art, which differs from the device of FIGS. 4 and 5 only in that the radio-frequency beam is not constrained by any reflector;
curve C2 illustrates the radiation pattern in the YOZ plane of a radio-frequency beam transmitted or received by the second radio-frequency antenna 11 of the device according to the prior art, which differs from the device of FIGS. 4 and 5 only in that the radio-frequency beam is not constrained by any reflector;
curve C3 illustrates the radiation pattern of a radio-frequency beam transmitted or received by the first radio-frequency antenna 9 of a device 5 such as illustrated in FIGS. 4 and 5, the radio-frequency beam being constrained by the first and second reflectors 1a, 1b;
curve C4 illustrates the radiation pattern of a radio-frequency beam transmitted or received by the second radio-frequency antenna 11 of a device 5 such as illustrated in FIGS. 4 and 5, the radio-frequency beam being constrained by the third reflector 1c (and the ground plane, where appropriate).

It may thus be seen that in a YOZ plane, for an angle of −50 degrees, the difference in gain between the radiation pattern of the first radio-frequency antenna 9 and the radiation pattern of the second radio-frequency antenna 11 of a device according to the prior art is 11 dB. Here, the YOZ plane is orthogonal to the plane of the printed circuit board.

For the same angle, the difference in gain between the radiation pattern of the first radio-frequency antenna 9 and the radiation pattern of the second radio-frequency antenna 11 of a device 5 according to the invention is 23 dB. This difference is explained by the presence of the first, second and third reflectors 1a, 1b, 1c. The two beams are thus better differentiated and hence the detection accuracy of the device 5 is increased. In addition, by virtue of the reflector 1c, a region, referred to as the shadow region (radiation weakened to −15 dB), is created in the angular range between 25° and 55°.

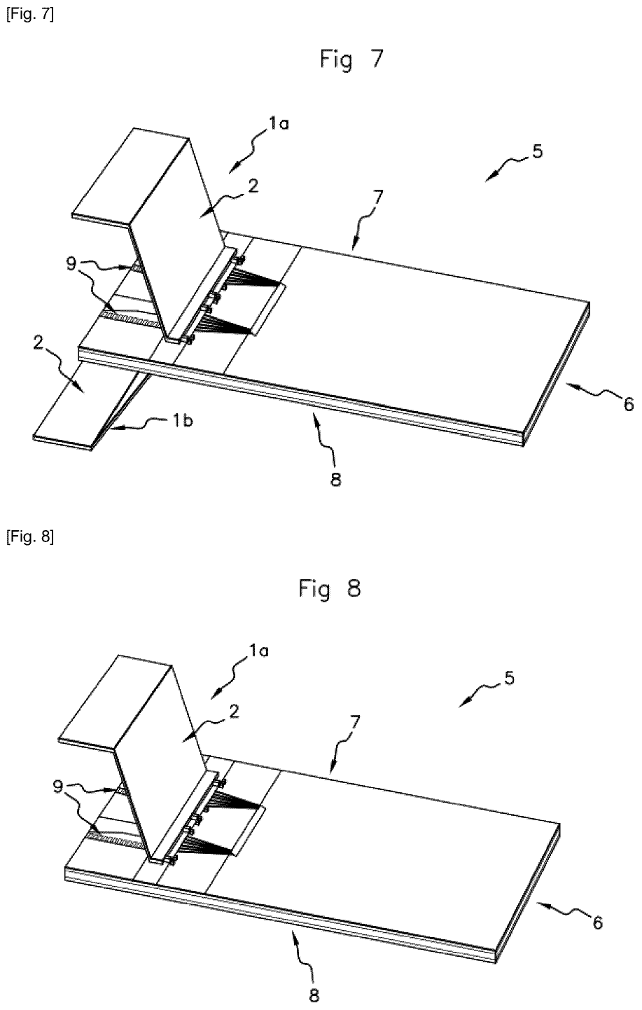

FIG. 7 illustrates another non-limiting embodiment of a device 5 according to one aspect of the invention. In this configuration, only two reflectors 1a and 1b are used on the first antenna. No reflector is positioned facing the second antenna. Thus, the secondary radiation of the first antenna is reduced, but no shadow region is created between the radiation patterns of the two antennas.

The device 5 comprises a printed circuit board 6 having a first side 7 and a second side 8 that are parallel to each other.

The first side 7 is equipped with a first radio-frequency antenna 9.

The device 5 further comprises a first reflector 1a. The reflecting plate 2 of the first reflector 1a lies facing the first antenna 9 and faces the first side 7 of the printed circuit board 6.

The device 5 also comprises a second reflector 1b. The reflecting plate 2 of the second reflector 1b lies facing the first antenna 9 and faces the second side 8 of the printed circuit board 6.

FIG. 8 illustrates a different non-limiting example of embodiment of a device 5 for detecting a gesture for automatically opening a vehicle hatch according to one aspect of the invention.

The device 5 comprises a printed circuit board 6 having a first side 7 and a second side 8 that are parallel to each other.

The first side 7 is equipped with a first radio-frequency antenna 9.

The sensor 5 further comprises a first reflector 1a. The reflecting plate 2 of the first reflector 1a lies facing the first antenna 9 and faces the first side 7 of the printed circuit board 6.

The printed circuit board 6 comprises a ground plane (not shown specifically), which may in particular lie facing the first radio-frequency antenna 9.

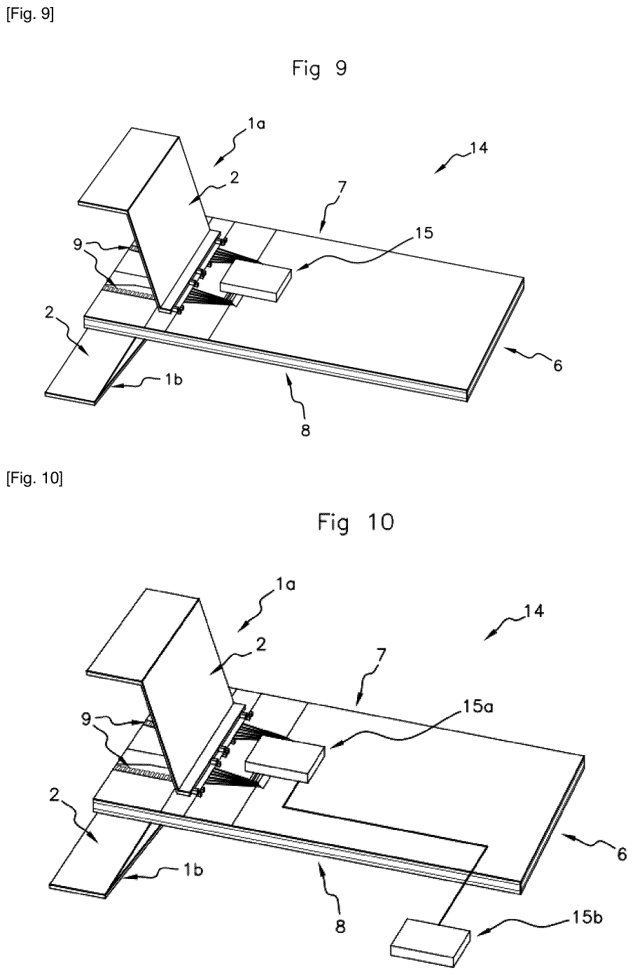

FIG. 9 shows a gesture detector 14 for controlling automatic opening of a motor-vehicle hatch, comprising:
a device 5 in conformance with the device 5 illustrated in FIG. 7; and
at least one computer 15, configured to receive as input a signal from at least one radio-frequency antenna 9, to carry out processing on this signal so as to detect a predetermined gesture made by a human operator, and to generate an instruction to open a motor-vehicle hatch when a predetermined gesture is detected. As illustrated in FIG. 9, this computer 15 may be placed on the printed circuit board 6.

In a different embodiment illustrated in FIG. 10, this computer 15 comprises first data-processing means 15a secured to the printed circuit board 6 and second data-processing means 15b external to the printed circuit board 6. These second data-processing means 15b may be formed by a vehicle control unit (VCU).

It will be noted that those skilled in the art should be able to conceive of various variants of the aforementioned aspects of the invention, for example obtained by modifying the shape of the reflecting plate that the reflector comprises and/or modifying the number of fastening tabs.

Moreover, the examples described are limited to opening a trunk, but it will be understood that the reflector 1, the device 5 and the detector 14 according to the invention may be applied to any type of hatch of a vehicle.

1. A device for transmitting and receiving radio-frequency signals, for a gesture detector controlling automatic opening of a motor-vehicle hatch, said device comprising:
a printed circuit board, passed through by at least one orifice and equipped with a first side and a second side that face each other, one of said first and second sides being equipped with a first radio-frequency antenna; and
at least one reflector, equipped with a reflecting plate capable of reflecting a radio-frequency beam and with at least one fastening tab, each fastening tab being integrally formed with the reflecting plate, at least one fastening tab of each at least one reflector being inserted into a respective orifice of the printed circuit board, and soldered to said printed circuit board at said orifice;
wherein
the at least one reflector includes a first reflector, the reflecting plate of which lies facing the first side of the printed circuit board, and
the at least one reflector further includes a second reflector, a reflecting plate of which lies facing the second side of the printed circuit board.

2. The device as claimed in claim 1, wherein the reflecting plate of at least one among the first and second reflectors comprises at least one notch that passes right through the thickness of said reflecting plate.

3. The device as claimed in claim 1, wherein the reflecting plate of at least one among the first and second reflectors is made of metal.

4. The device as claimed in claim 1, wherein at least one among the first and second reflectors has a major surface, which is inclined obliquely relative to the plane of the printed circuit board, with an angle of inclination between 20° and 70°.

5. The device as claimed in claim 1, wherein the first reflector and the second reflector flank the first radio-frequency antenna.

6. The device as claimed in claim 1, wherein:
one of the first and second sides of the printed circuit board is equipped with a second radio-frequency antenna; and
the at least one reflector includes two sets of reflectors, where each set of one or more reflectors is associated with a respective one of the first and second radio-frequency antennas.

7. The device as claimed in claim 6, wherein a first set of one or more reflectors comprises the first and second reflectors (1a, 1b), and a second set of one or more reflectors comprises a third reflector (1c).

8. The device as claimed in claim 1, wherein the printed circuit board comprises a ground plane, each fastening tab of each reflector being electrically connected to said ground plane.

9. A gesture detector for controlling automatic opening of a motor-vehicle hatch, comprising:
a device as claimed in claim 1; and
at least one computer, configured to receive as input a signal from the at least one radio-frequency antenna, to carry out processing on this signal so as to detect a predetermined gesture made by a human operator, and to generate an instruction to open said motor-vehicle hatch when a predetermined gesture is detected.

10. The device as claimed in claim 2, wherein the reflecting plate of at least one among the first and second reflectors is made of metal.
